(19) United States
(12) Patent Application Publication
(10) Pub. No.: US 2009/0300722 A1
(43) Pub. Date: Dec. 3, 2009

(54) SUPPORT FOR INTEGRATED WLAN HOTSPOT CLIENTS

(75) Inventors: Henry Haverinen, Jyvaskyla (FI); Mikko Jaakkola, Lempaala (FI); John Loughney, Espoo (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/097,510

(22) PCT Filed: Dec. 16, 2005
(86) PCT No.: PCT/IB05/03807

§ 371 Date: Nov. 13, 2008

(51) Int. Cl. H04L 29/06; G06F 15/16

(52) U.S. Cl. 726/4; 709/227

(57) ABSTRACT

The invention proposes a method and a network device comprising an operation entity (3) for handling network connection and at least one access client entity (1, 2) providing connection handling to a specific network access device, wherein the operation entity is adapted to identify a need for a network connection and to inform the access client entity, and the at least one access client entity is adapted to perform an authentication. Hence, an authentication procedure is delegated to a separate entity so that depending on the specification of a specific network connection, a suitable access entity for performing the authentication can be selected.

### BACKGROUND OF THE INVENTION

1. Field of the Invention

The invention relates to a method and a network device for handling a network connection, wherein an access client entity and an operation entity of the network device can co-operate.

2. Description of the Related Art

The invention is in particular related to WLAN (Wireless Local Area Network) Hotspot Clients, although it is not limited thereon.

WLAN (Wi-Fi) has a large deployed base in enterprises, homes and in hotspots. There has been a business model developed around the use of public access Wi-Fi; with service providers providing either time based charging or subscription based charging. This industry is still in its infancy, with many players competing for position. There are a number of proprietary mechanisms deployed for enabling provider authorization and authentication of users within a hotspot.

Many hotspot operators are small, and in general the operators have very heterogeneous equipment. The service is very typically based on the “old” IEEE 802.11b standard. Most hotspots do not support the new security standards (IEEE 802.1x or WiFi Protected Access), or the new physical layer standards such as the fast IEEE 802.11g or the 5 GHz IEEE 802.11a. Therefore, WLAN aggregators (companies which provide brokering and aggregation for many different hotspot deployments) generally tend to concentrate on very simple equipment and HTTP-based (browser based) access control. In practice, this means users need to start a web browser, and browse to a web page. The hotspot captures their traffic and redirects them to a centralized login page, where the user will need to present the proper credentials for gaining access in the hotspot.

Many WLAN aggregators and hotspot operators have developed proprietary automated logon clients, by which the user can discover the hotspot and log in easily, usually with one click. The hotspot clients are stand-alone networking applications, and the authentication protocol is most often based on IP-layer protocols such as HTTP, TLS, XML, and not on IEEE standards.

The main logical functions of a Wi-Fi hotspot client are summarized here.

Many hotspot clients include a directory tool that can be used off-line, for example before a business trip, to list hotspots per location, so that user can find out the nearest compatible Wi-Fi hotspot. The information in the directory can be regularly updated, and it may include maps and images of the location.

The hotspot client usually includes a WLAN Sniffer, which shows locally available WLAN networks. At least the network name (SSID (Service Set IDentifier)) and the signal strength are displayed. Possibly, the sniffer can show richer information in addition to SSID, such as whether this is a “Sonera Homerun” network—or even hide the technical SSID parameter from the user completely. In the existing Windows and Pocket PC solutions, the WiFi sniffer tool can usually be used in manual network selection—to select the network to join. The user can also use the sniffer to manage SSID lists, network priorities, or other connection settings of the provider for automatic network selection. There is usually a “Connect” button, by which the user can launch the automated log-on protocol. The WLAN sniffer, when combined with the directory tool enables users to quickly know which hotspots they have access to, via their WLAN subscription.

The third feature of current WiFi clients is the actual logon client. It provides for easy authentication, so that the user does not need to use the browser. Username, realm and password (or other credentials) are stored in the device. In cases when Network Access Identifier decoration is required, it is automatically applied. For compatibility with legacy 802.11b-only networks, the logon protocol is typically an IP-based automated variant of web browser login.

Current hotspot clients are stand-alone applications, which the user must explicitly launch.

In the following, some more sophisticated approaches are described, in particular with respect to Symbian WLAN Networking and Seamless Roaming.

In Nokia's WLAN phones, WLAN settings can be included in Internet Access Point settings. The Internet Access Point setting can contain a SSID, or in the future, a list of SSIDs. The connection monitor, bearer manager and mobility policy manager components constantly try to detect, which Internet Access Points are currently available. It is also possible to learn, which SSIDs are available in the current neighborhood. For WLAN Internet Access Points, the availability is based on WLAN scanning and the SSID settings of each WLAN Internet Access Point.

Internet Access Points that provide connectivity to the same target network, such as the office intranet or the public Internet, can be grouped into a service network. The Internet Access Points can be given priorities, so that when opening a connection to a certain service network, the middleware can automatically select the most preferred available Internet Access Point. In the Nokia platform, when creating a connection, the application may use the RConnection API (Application Programming Interface) to open the connection to a certain service network. Once the connection has been successfully established, the application can start using it.

When the user wants to perform a task, such as send an e-mail message, with a Nokia mobile device, the user can usually directly launch the appropriate application, such as the e-mail client. When the e-mail client needs a connection to the Internet, the system will establish the connection. The e-mail client may be pre-configured with the correct connection information, or the user may be prompted to select the connection among a list of available connections. Even when a Virtual Private Network (VPN) connection to a private network is required, the system will automatically establish the VPN connection. Hence, the user does not need to switch on any radios or VPN clients before launching the e-mail application.

A problem with the present WLAN hotspot authentication mechanisms is that the user is required to use the WLAN connection from a separate application (either the browser or stand-alone hotspot client) in order to be allowed to use the hotspot service, before using the e-mail application in the above-mentioned example.

There is a user need for automated roaming between Internet Access Points; which is also supported in the Nokia platform. In automated roaming, the application can receive a notification when a more preferred Internet Access Point within the application's current service network has become available. The application can then close its current connection and reconnect using the newly discovered Internet Access Point. In network-level roaming, a middleware component, such as a VPN client or a mobile IP client manages mobility between underlying Internet Access Points, transparently to the applications.

Thus, summarizing, the “normal” way for user to gain WLAN access via a hotspot is:

Manual Log-In
1. A user reads a sign, showing that there is a hotspot.
2. User open the browser and tries to browse to a well-known web page.
3. The user is redirected to the hotspot provider's web page.
4. The user is required to enter a user name & password in order to be authenticated & allowed to access hotspot.

Semi-Automated Mechanism
1. User has installed software that has pre-configured authentication mechanism.
2. User clicks on software which finds a hotspot.
3. The user selects a hotspot, which calls an authentication ‘script’.
4. The script then authenticates the user to a backend server
5. The user can then use the hotspot freely.

That is, the user opens a browser when he is inside a hotspot. When the user attempts to browse to a webpage, the user is re-directed to a portal page. The user can then enter a User Name/Password. Once authenticated, the user is able to use the WLAN network. This is in particular inconvenient for handheld devices (like smart phones) as it requires the user to be aware of the surrounding wireless networks and perform more steps in order to be connected.

Alternately, some hotspot aggregators use scripts which signal a backend server, mimicking the web page based login described above. These scripts are not completely automated, however, and require user action.

Thus, still some manual input from the user is required in order to connect and de-connect via a Hotspot. That is, the user of a mobile terminal having WLAN has to first establish a link layer connection and thereafter start the hotspot client in order to be able to use the network connection, e.g., to use the Internet.

Additionally, wireless signals are affected by environmental factors. Walls, for example, can reduce the signal strength of wireless radios. Other wireless networking technologies, such as Bluetooth, can cause interference with WLAN signals. Therefore, a user might loose or gain a wireless connection based upon environmental issues. If a user loses a connection to the WLAN hotspot because another user happens to use a Bluetooth-enabled device, then the WLAN user must perform the steps listed above to-regain the connection to the WLAN hotspot.

### SUMMARY OF THE INVENTION

Hence, it is an object of the present invention to solve the problem mentioned above and to provide support for an easy and automated logon to an access entity such as a WLAN hotspot.

This object is solved by a method for handling a network connection of a network device comprising an operation entity for handling network connection, wherein at least one access client entity providing connection handling to a specific network access device is connectable to the operation entity, the method comprising the steps of
identifying, by the operation entity, a need for a network connection,
requesting the access client entity to perform authentication, and
performing, by the access client entity, the authentication.

Alternatively, the object is solved by a method for operating an operation entity for handling network connection, wherein at least one access client entity providing connection handling to a specific network access device is connectable to the operation entity, the method comprising the steps of
identifying, by the operation entity, a need for a network connection, and
requesting the access client entity to perform authentication.

As a further alternative, the above object is solved by a method for operating an access client entity for handling a network connection to a specific network access device, connectable to a network device comprising an operation entity for handling network connection, the method comprising the steps of
receiving a request from the operation entity to perform authentication, and
performing the authentication.

Moreover, the above object is solved by a network device comprising an operation entity for handling network connection and at least one access client entity providing connection handling to a specific network access device, wherein
the operation entity is adapted to identify a need for a network connection and to inform the access client entity, and
the at least one access client entity is adapted to perform an authentication.

Alternatively, the above object is solved by an access client entity providing connection handling for a specific network access device, comprising
means for receiving a request to perform authentication from an operation entity, and
means for performing the authentication.

Further alternatively, the above object is solved by an operation entity for handling network connection, the operation entity comprising
means for identifying a need for a network connection, and
means to request an access client entity providing connection handling for a specific network access device to perform an authentication.

Hence, according to the invention, the authentication procedure is delegated to a separate element, namely an access client entity (an example therefore being a hotspot client). This access client entity can be specific for a specific network access device, so that no manual input from the user is required.

Thus, according to the invention, the authentication is integrated into the connection subsystem.

Hence, the authentication process is simplified allowing any application, such as email, to gain access to the hotspot without requiring additional steps by the user.

According to a further aspect of the invention, the operation entity may be informed about the result of the authentication by the access client entity, and, in case the authentication was successful, the operation entity may allow use of the network connection.

According to another aspect of the invention, a plurality of access client entities may be provided, and an access client entity of the plurality of access client entities may be selected based on the need for a network connection.

According to another aspect of the invention, a message may be sent from the access client entity to the operating system client to request the operating system client to notify when a certain connection profile becomes available. Alternatively, a message may be sent from the operating system client to the access client entity to request the access client entity to notify when a certain connection profile becomes available.

According to another aspect of the invention, a message may be sent from the operation entity to the access entity client by which the operation entity requests the access client entity to perform the authentication.

According to a further aspect of the invention, a message may be sent from the operation entity to the access entity client by which the operation entity requests the access client entity to perform a de-authentication.

According to another aspect of the invention, a message may be sent from the access client entity to the operation entity by which the access client entity indicates to the operating system that the authentication has been successfully performed.

According to another aspect of the invention, a message may be sent from the access client entity to the operation entity by which the access client entity indicates to the operating system that de-authentication has been successfully performed.

According to a further aspect of the invention, a message may be sent from the access client entity to the operation entity by which the access client entity indicates to the operating system that authentication/de-authentication has failed.

According to another aspect of the invention, a modification of a network connection setting by a user input is prohibited.

According to a further aspect of the invention, an access client entity is registered to the operation entity.

According to another aspect of the invention, an access client entity is linked to a profile, wherein in the authenticating step, the operation entity informs the access client entity linked to the profile in case a connection with the profile is to be established.

### BRIEF DESCRIPTION OF THE DRAWINGS

The invention is described by referring to the enclosed drawings, in which:

FIG. 1 shows a block diagram of the architecture according to an embodiment of the present invention,

FIG. 2 shows a message sequence chart illustrating a registration of a hotspot client according to the embodiment of the present invention,

FIG. 3 shows a message sequence chart illustrating an automatic hotspot login according to the embodiment of the present invention,

FIG. 4 shows a message sequence chart illustrating an automatic hotspot logoff according to the embodiment of the present invention,

FIG. 5 shows a message sequence chart illustrating a WLAN availability discovery and authentication according to the embodiment of the present invention, wherein the hotspot client manages discovery settings,

FIG. 6 shows a message sequence chart illustrating an WLAN availability discovery and authentication according to the embodiment of the present invention, wherein the OS manages discovery settings,

FIG. 7 shows a message sequence chart illustrating an the basic middleware enabled hotspot authentication according to the embodiment of the present invention in more detail,

FIG. 8 shows a message sequence chart illustrating the WLAN availability discovery and authentication according to the embodiment of the present invention in more detail, and

FIG. 9 shows a message sequence chart illustrating the WLAN hotspot de-authentication according to the embodiment of the present invention in more detail.

### DETAILED DESCRIPTION OF THE PREFERRED EMBODIMENT

In the following, a preferred embodiment of the present invention is described by referring to the attached drawings.

As described above, currently WLAN hotspot clients are currently used for an automated hotspot logon. To allow the implementation of such clients to operating systems such as Symbian, and to integrate the automated WLAN hotspot logon with networking of such an operating system, according to the embodiment there is provided
a mechanism to delegate the management of WLAN selection (SSID) to a separate client, and
a mechanism to integrate a WLAN hotspot client with seamless roaming and with native user interfaces.

In more detail, according to the present embodiment, the following is provided:

A WLAN Internet Access Point setting that indicates that the SSID settings are managed by an external software entity. When a WLAN Internet Access Point setting has been configured with such an indication, the operating system knows that it is not responsible for detecting the availability of the Internet Access Point. The operating system may also detect that the user should not be able to use the standard user interfaces to modify the WLAN settings, because WLAN settings are managed by a separate software entity. An embodiment of this setting is a special value of the existing SSID field that indicates an undefined SSID.

Moreover, an Application Programming Interface (API) is defined between the operating system and a 3rd party hotspot client. The API enables the following features:
Subsequent installation of a 3rd party hotspot client or several clients
Automatic activation of a 3rd party hotspot client (or a notification to the hotspot client) by the WLAN subsystem or the operating system when the WLAN subsystem or the operating system detects a need to log on to a WLAN network discovered by the WLAN subsystem system
Capability to deliver notifications of events from the hotspot client to the WLAN subsystem or the operating system. Notifications could be given in the following events: discovery of a suitable network by the hotspot client, successful authentication, unsuccessful authentication (with various reason codes), authenticated session terminated, successful log-out, unsuccessful log-out
Capability to deliver notifications of events from the WLAN subsystem or the operating system to the hotspot client. Notifications could be given in the following events: need to log in, need to log out.

Implementing roaming decisions or automatic Internet Access Point selection by the operating system, based on notifications given by a 3rd party hotspot client. For example, the “link up” notification about a WLAN Internet Access Point should be given to an application only after the authentication has been successfully completed, or mobile IP registration should be tried after successful authentication.

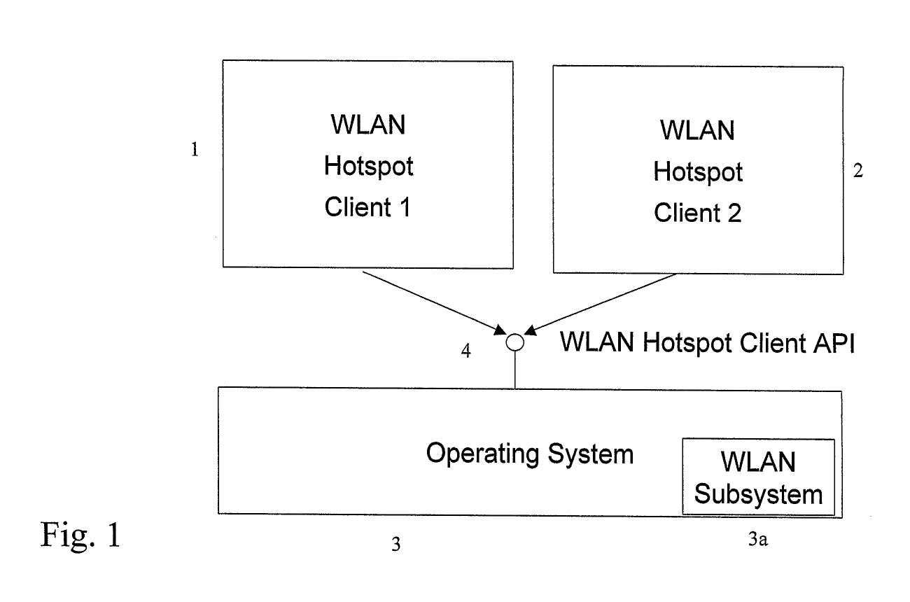

In the following, the principles of the embodiment are described by referring to FIGS. 1 to 6.

In FIG. 1, an overview of the software architecture is shown, which is provided in a network device such as a smart phone, laptop, PDA or the like. Reference numeral 1 denotes a WLAN hotspot client 1 as an example for a first access client entity (access client device), and reference numeral 2 denotes a WLAN hotspot client 2 as an example for a second access client entity (access client device). Reference numeral 3 denotes an Operating System (OS) as an example for an operation entity (operation device), and reference numeral 3a denotes a WLAN subsystem integrated in the operating system 3. Reference numeral 4 denotes a WLAN hotspot client API.

Preferably, the following features should be available in the API 4.
The API should be able to register a 3rd party hotspot client (e.g., the WLAN hotspot client 1 and/or 2) to the authentication framework of the operating system. The hotspot client might be implemented as a dynamic link library that exports a standard hotspot client interface. Upon the registration, the operating system learns the file name of the library, and the operating system will later be able to call various methods in the hotspot client.
The API 4 should be able to link a 3rd party hotspot client (e.g., the WLAN hotspot client 1 and/or 2) to a profile. This means that when a connection with the profile is established, the operating system will call the linked hotspot client to perform authentication.

In addition, the following primitives should be defined for the API:
An API primitive by which the hotspot client can request the operating system to notify when a certain connection profile becomes available (used when the operating system manages WLAN network discovery settings).
An API primitive by which the operating system can request the hotspot client to notify when a certain connection profile becomes available (used when the hotspot client manages WLAN network discovery settings).
An API primitive by which the operating system can request the hotspot client to perform authentication.
An API primitive by which the operating system can request the hotspot client to perform de-authentication.
An API primitive by which the hotspot client can indicate to the operating system that authentication has been successfully performed.
An API primitive by which the hotspot client can indicate to the operating system that de-authentication has been successfully performed.
An API primitive by which the hotspot client can indicate to the operating system that authentication/de-authentication failed.

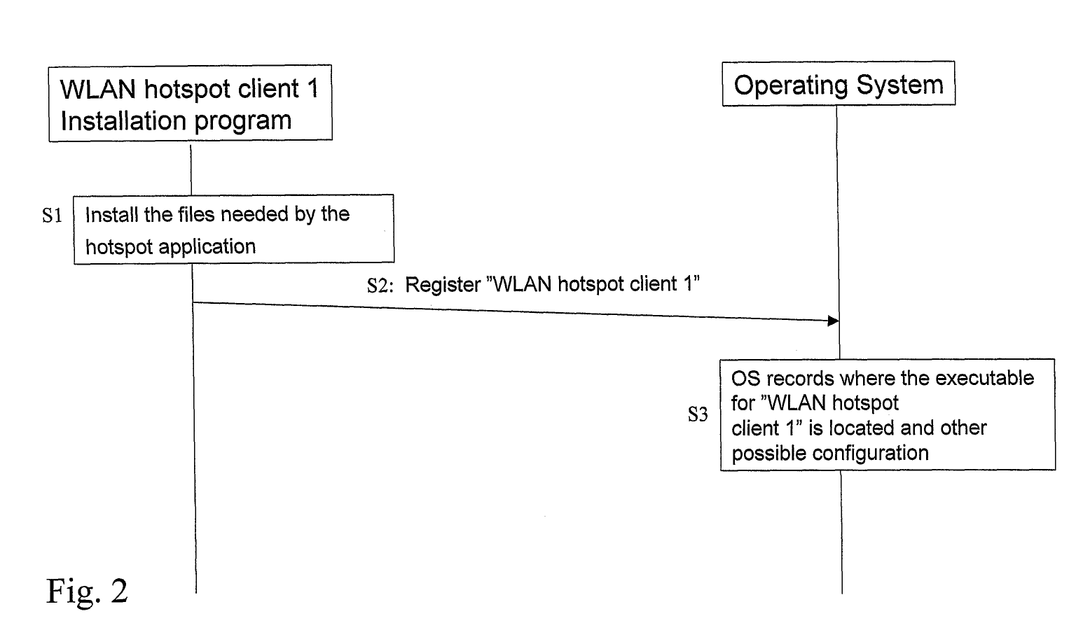

In the following, the operation of the operating system and the hotspot clients in connection with the API and the use of the API primitives mentioned above are described in the following in connection with FIGS. 2 to 6.

FIG. 2 shows a message sequence chart of the registration of a hotspot client, in this example, of the WLAN hotspot client 1. For example, this registration procedure may be carried out at the first time the network device connects to the particular hotspot, or beforehand via a website of the operator of the hotspot. Alternatively, the registration could be carried out when the hotspot client software is installed. It could be upon the first connection or beforehand. The registration could also be done as part of the software build process by the manufacturer of the device.

The procedure starts with starting the installation program of the WLAN hotspot client 2, in which the files needed by the hotspot application are installed (step S1). In step S2, a register message “WLAN hotspot client 1” is sent to the operating system. In turn, the operating system records where the executable for “WLAN hotspot 1” is located and other configuration (step S3). As mentioned above, the hotspot client may be implemented as a dynamic link library, and upon the registration, the operating system learns the file name of the library.

After the “WLAN hotspot client 1” has been installed, it is possible to configure the operating system's setting for a certain profile to use “WLAN hotspot client 1”. That is, the hotspot client is linked to a profile, as described above.

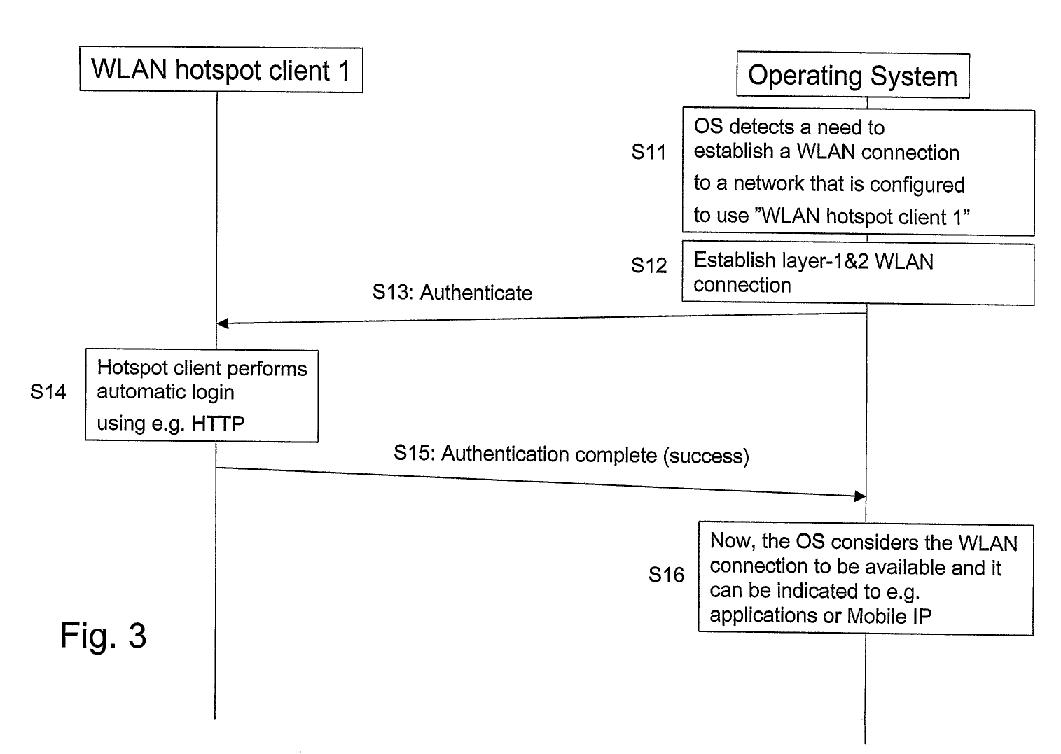

FIG. 3 shows a message sequence chart of an automatic hotspot login.

In step S11, the operating system (OS) detects a need to establish a WLAN connection to a network that is configured to use “WLAN hotspot client 1”. After this, a layer 1 and 2 WLAN connection is established in step S12. In step S13 an Authenticate message is sent to the WLAN hotspot client 1. That is, this message is the API primitive by which the operating system can request the hotspot client to perform authentication, as described above.

The hotspot client 1 performs, in turn, an automatic login, using, e.g., HTTP (Hypertext Transfer Protocol), at an access point (not shown) of the corresponding hotspot (step S14). In case of a successful authentication, the WLAN hotspot client sends an Authentication complete (success) message to the operating system in step S15. This message is the API primitive by which hotspot client can indicate to the operating system that the authentication has been successfully performed. In case of an unsuccessful case, the hotspot client 1 would send the API primitive described above by which the hotspot client can indicate to the operating system that the authentication has failed.

After this, the operating system considers the WLAN connection to be available and it can be indicated to the application or Mobile IP, for example (step S16). Thus, a full automatic hotspot login is performed, in which no further manual input from the user is necessary.

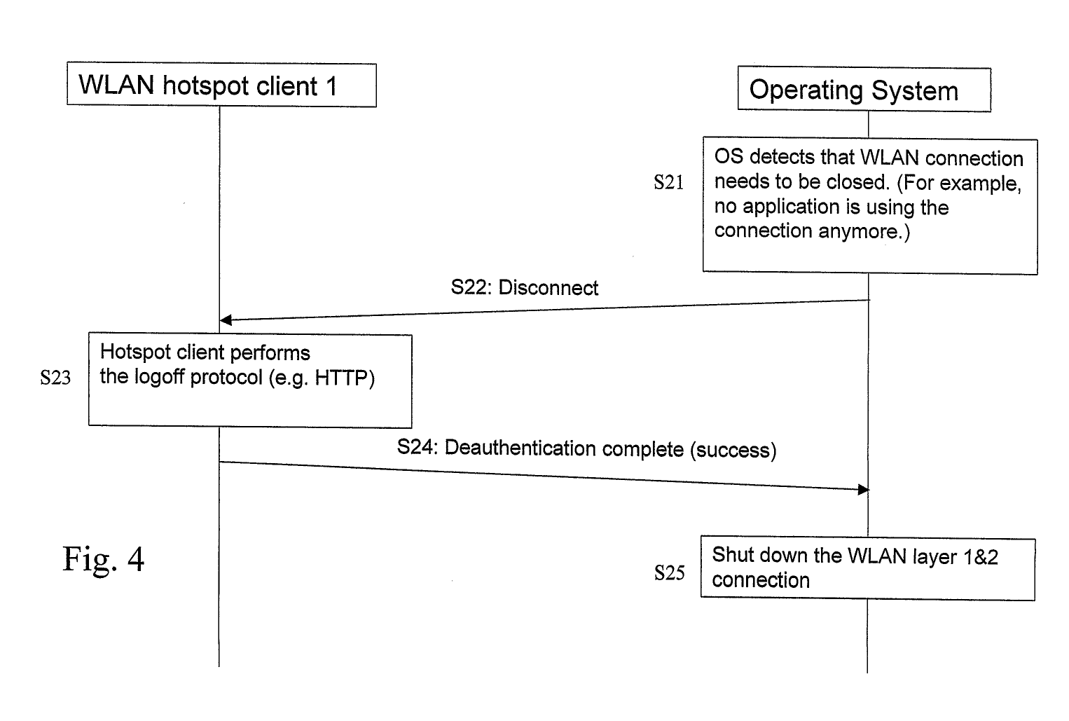

FIG. 4 shows a message sequence chart in which an automatic hotspot logoff is illustrated. An automatic hotspot logoff might be performed in order to save unnecessary login time or to save resources.

In step S21, the operating system detect that a WLAN connection needs to be closed. For example, no application is using the connection anymore. Thus, in step S22, it sends a Disconnect message to the WLAN hotspot client 1. This message is the API primitive mentioned above by which the operating system can request the hotspot client to perform a de-authentication.

In turn, the WLAN hotspot client 1 performs a logoff protocol, e.g., by using HTTP (step S23). In case of a successful de-authentication, it sends a De-authentication complete (success) message to the operating system in step S24. This message is the API primitive mentioned above by which the hotspot client can indicate to the operating system that the de-authentication has been successfully performed. In case of an unsuccessful de-authentication, the API primitive is sent, by which the hotspot client can indicate to the operating system that the de-authentication has failed.

In step S25, the operating system shuts down the WLAN layer 1 and 2 connection (established in step S12 shown in FIG. 3). Thereafter, the WLAN connection is closed.

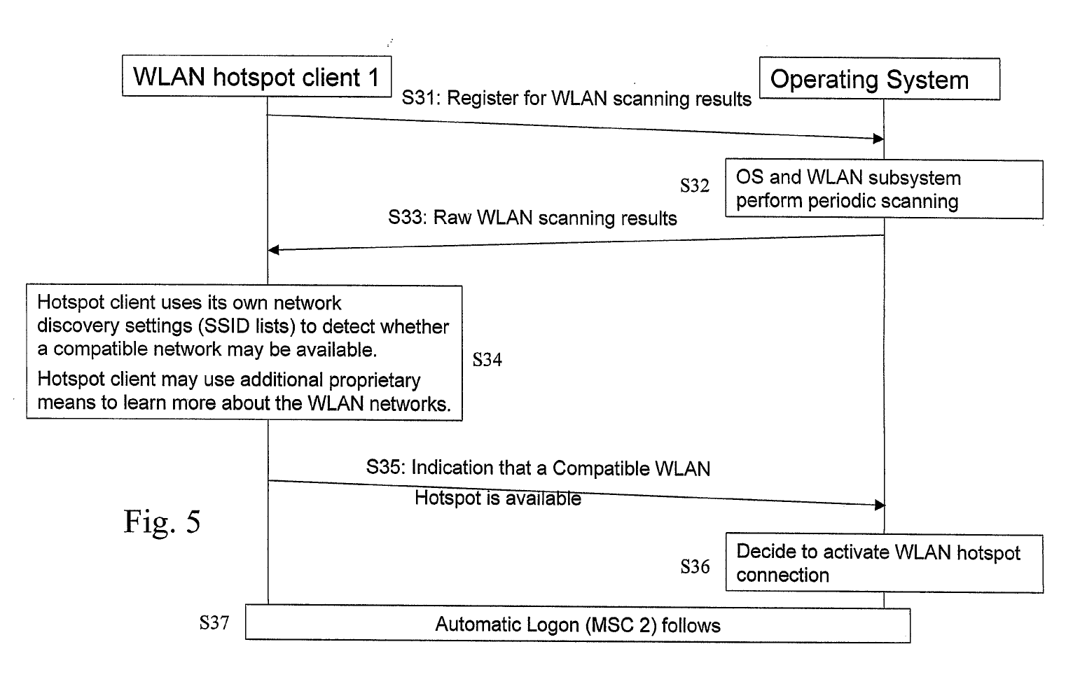

In FIG. 5, a message sequence chart is shown illustrating a WLAN availability discovery and authentication.

In step S31, the WLAN hotspot client 1 sends a message Register for WLAN scanning results to the operating system. This is the API primitive mentioned above by which the hotspot client can request the operating system to notify when a certain connection profile becomes available.

In turn, the operating system and the WLAN subsystem (3a in FIG. 1) perform periodic scanning (step S32). In step S33, the operating system sends raw WLAN scanning results to the hotspot client. Then, the WLAN hotspot client uses its own network discovery settings (e.g., SSID lists) to detect whether a compatible network is available (step S34). The hotspot client may use additional proprietary means to learn more about the WLAN networks. In case of success, the hotspot client sends a message including an Indication that a compatible WLAN hotspot is available to the operating system in step S35. In response to this, the operating system decides to activate a WLAN hotspot connection with this compatible WLAN hotspot in step S36. In step S37, the automatic logon is carried out, as described above in connection with FIG. 3.

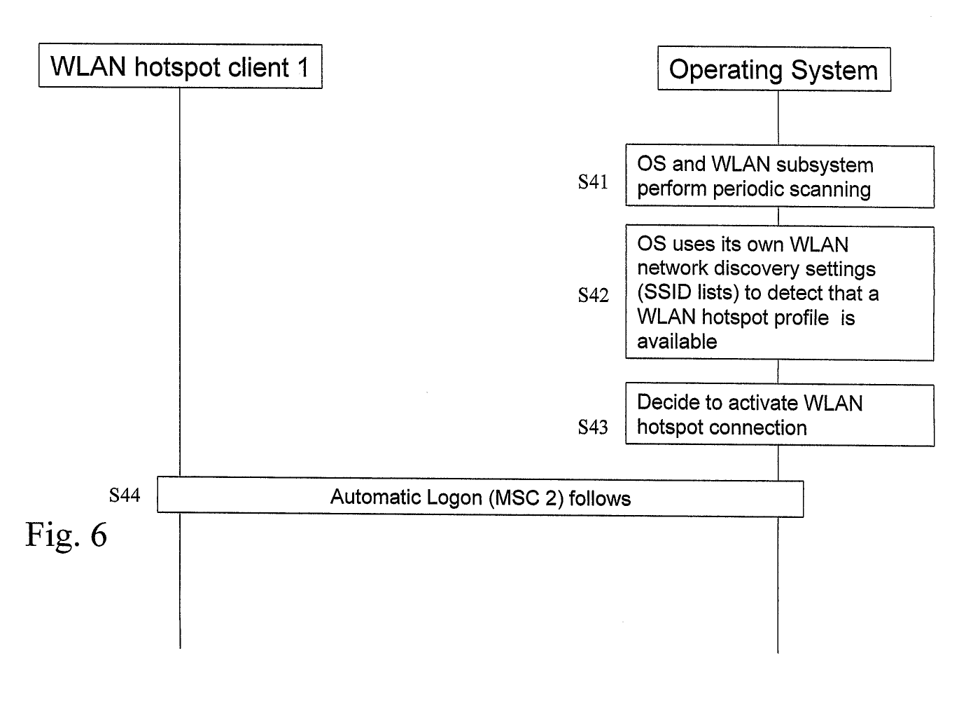

In FIG. 6, also a message sequence chart illustrating a WLAN availability discovery and authentication is shown, however, in this case the operating system manages the discovery settings.

In step S41, the operating system and the WLAN subsystem perform periodic scanning. In step S42, the operating system uses its own network WLAN discovery settings (e.g., SSID lists) to detect that a WLAN hotspot profile is available. In this step, the operating system may send the API primitive described above to the hotspot client by which the operating system can request the hotspot client to notify when a certain connection profile becomes available.

In case of success, the operating system decides in step S43 to activate the WLAN hotspot connection. Thereafter, the automatic logon described above in connection with FIG. 3 follows.

Thus, according to the present embodiment, a ‘standard’ API is created into the connection mechanism to automate hotspot login. This API is able to call external mechanisms, such has 802.1x mechanisms or proprietary authentication scripts so that users would need to perform minimal steps to use hotspots.

This API is tightly integrated into the WLAN connection management system in handhelds.

Hence, it is not necessary for the user to launch specialized software separately to access hotspots, and a common look & feel across multiple service providers is possible.

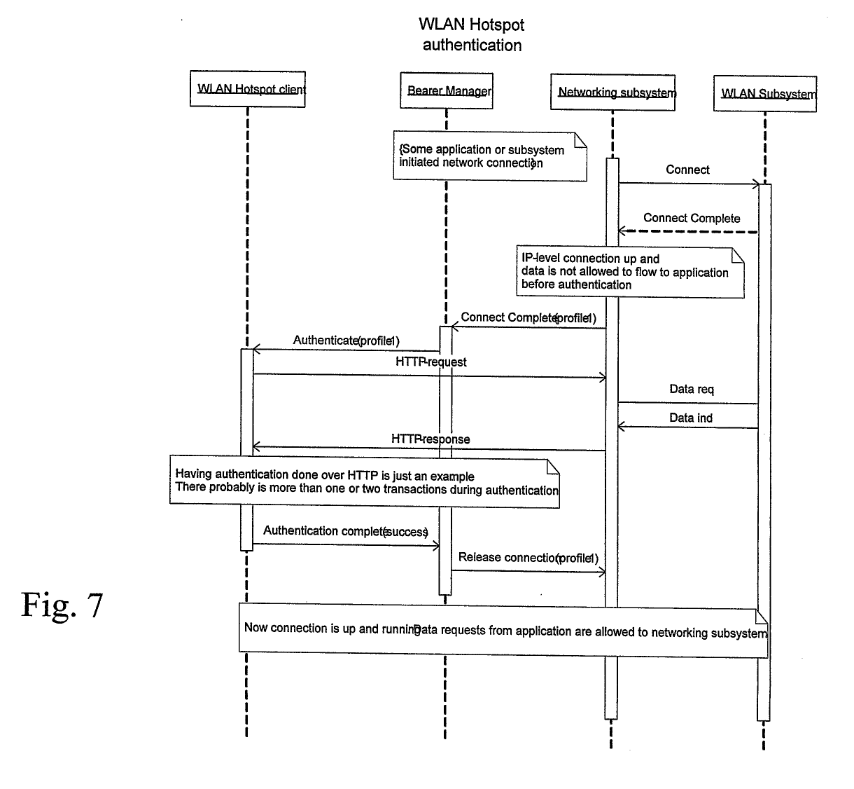

In the following, the WLAN hotspot authentication scenarios described above are described in more detail by referring to FIGS. 7 to 9.

FIG. 7 shows a message sequence chart illustrating a basic middleware enabled hotspot authentication.

In principle, this is a more detailed procedure as described above in connection with FIG. 3. In particular, FIG. 3 shows some more functions of the operating system, namely the WLAN subsystem, a network subsystem and a bearer manager. The procedure may start when some application or subsystem initiates a network connection. Then, the network subsystem sends a Connect message to the WLAN subsystem. In this way, the WLAN layer 1 and 2 connection is established (similar to step S12 in FIG. 3). It is noted that before authentication, no IP-level connection up and data is allowed to flow to application.

The network subsystem selects a profile 1 and sends a message Connect Complete (profile 1) to the bearer manager, which forwards an Authentication (profile 1) to the WLAN hotspot client. That is, this message is the API primitive by which the operating system can request the hotspot client to perform authentication (similar to step S13 in FIG. 3). Thereafter, the WLAN hotspot client performs the authentication by sending a HTTP request to the network subsystem, which sends a data request to the WLAN subsystem, which transmits the data to the hotspot. A corresponding response is received via the WLAN subsystem and forwarded to the network subsystem, which sends a HTTP response to the WLAN hotspot client. This procedure corresponds to step S14 of FIG. 3. It is noted that the authentication by using HTTP is only an example. Moreover, there may be more than only one or two transactions during the authentication.

In case of a successful authentication, an Authentication complete (success) message is sent to the bearer manager. This is the API primitive by which the hotspot client can indicate to the operating system that authentication has been successfully performed (similar to step S15 in FIG. 3).

After this, a Release connection (profile 1) is sent to the networking subsystem in order to release the connection after the successful connection. Thereafter, the connection is up and running. Data requests from the application are allowed to the network subsystem.

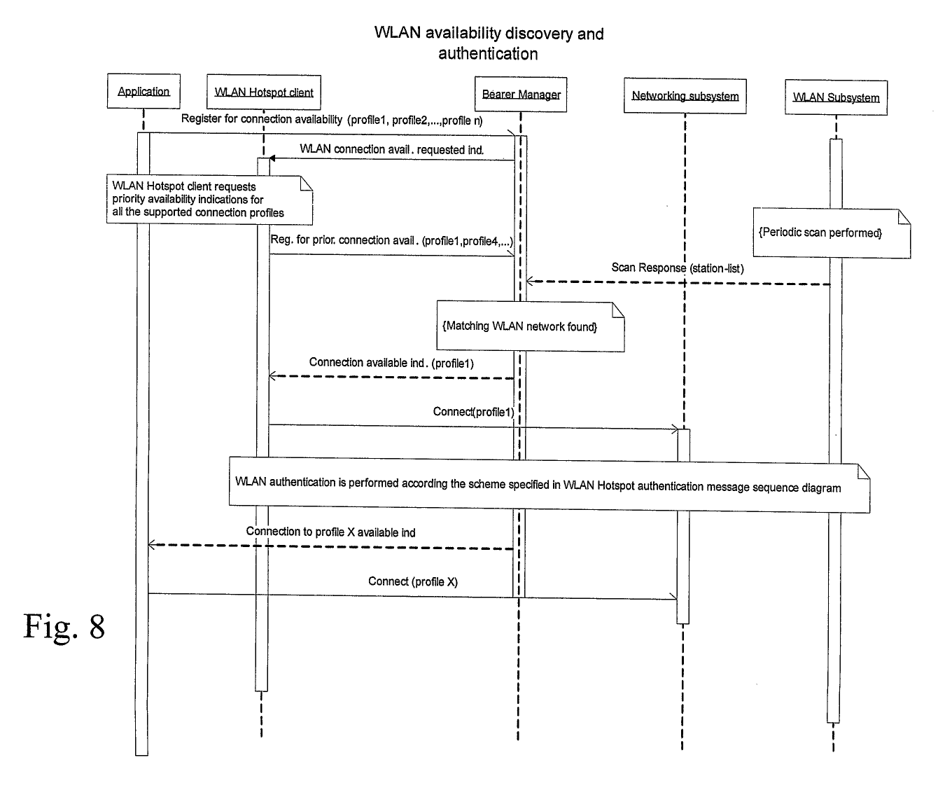

FIG. 8 shows a message sequence chart illustrating how discovery and authentication could be combined into a single operation.

The procedure starts when an application registers for connection availability regarding one or more profiles (profile 1, profile 2, . . . profile n) with the bearer manager. The bearer manager sends a WLAN connection availability requested indication message to the WLAN hotspot client. In turn, the WLAN hotspot client may request priority availability indications for all the supported connection profiles and sends a corresponding message Register for priority connection availability (profile 1, profile 4, . . . ), assuming that profile 1 has the highest priority, profile 4 as the second highest priority and so on.

Meanwhile, the WLAN subsystem performs periodic scanning, and send a Scan response including a station list. The bearer manager checks whether a there is a matching WLAN network. In case a matching WLAN network is found, a connection availability indication (profile 1) is sent to the WLAN hotspot client, assuming that a network corresponding to profile 1 is available. The WLAN hotspot client sends then a Connect (profile 1) to the networking subsystem, so that then a WLAN authentication is performed according to the scheme as shown in FIG. 7. Thereafter, a connection to profile X (e.g., profile 1 as described above) available indication is sent to the WLAN hotspot, which sends a Connect (profile X) to the bearer manager.

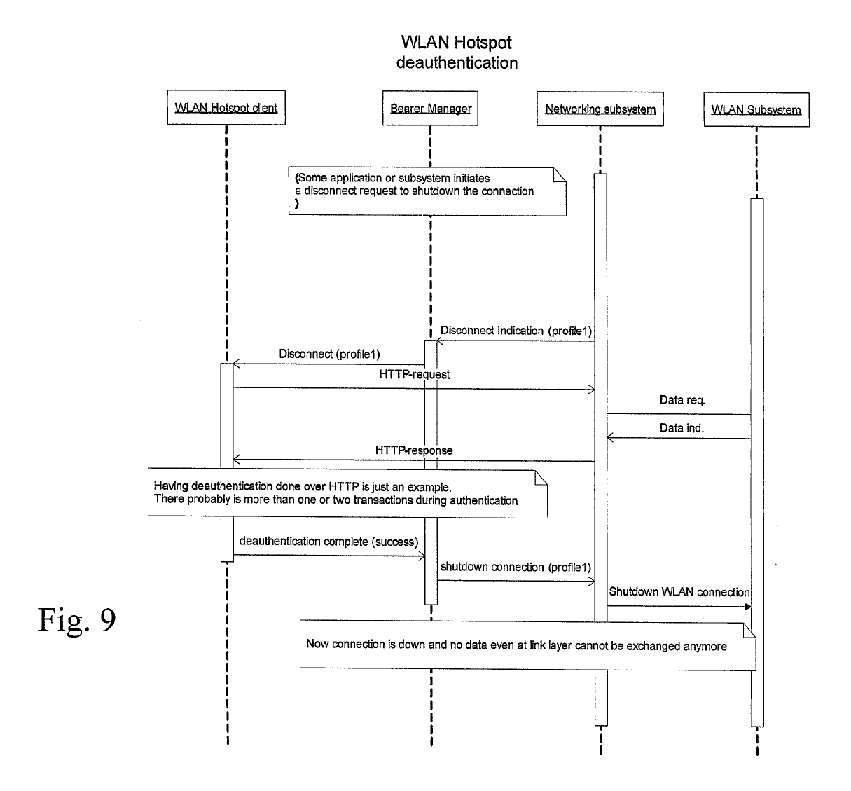

FIG. 9 shows a message sequence chart illustrating a WLAN hotspot de-authentication.

Similar as described above in connection with FIG. 4, the de-authentication may start when some application or subsystem initiates a disconnect request to shutdown the connection, for example, when it is discovered that the connection is no longer needed.

Thus, the networking subsystem issues a disconnect indication (profile 1) to the bearer manager, which sends a Disconnect (profile 1) to the WLAN hotspot client. That is, this is the API primitive by which the operating system can request the hotspot client to perform de-authentication (similar to step S22 in FIG. 4). The hotspot client performs the logoff by using HTTP, similar as in the case of performing the authentication (similar to step S23 in FIG. 4). It is noted that performing the de-authentication by using HTTP is only an example. Moreover, there may be more than one or two transactions during the de-authentication.

When the de-authentication has been successful, the WLAN hotspot client sends a de-authentication complete (success) message to the bearer manager. This is the API primitive by which the hotspot client can indicate to the operating system that the de-authentication has been successfully performed (similar to step S24 in FIG. 4). The bearer manager sends a corresponding message shutdown connection 8profile 1) to the networking subsystem, which issues a shutdown WLAN connection message to the WLAN subsystem.

Thereafter, the connection is down and no data even at link layer can be exchanged anymore.

Thus, according to the present embodiment, it is possible to implement 3rd party hotspot logon clients, which improve the usability of public WLAN. In particular, the operating system has the knowledge about which profiles are available, which networks (SSIDs). This information is used by the hot spot clients to do the authentication.

That is, according to the embodiment, integration of 3rd party hotspot clients with native user interfaces, automatic connection selection, and seamless roaming are possible.

Hence, this invention enables seamless roaming when there are several higher layer (higher than link layer) authentications needed, for example, when several hotspot clients are used. This is possible due to the automatic authentication.

In particular when a WLAN hotspot client is implemented on a mobile device, such as a Symbian phone, the following advantages are achieved according to the invention:
A 3rd party application is enabled to manage its own WLAN settings, compatibly with the existing WLAN Internet Access Point definition. The existing middleware should be able to detect when a WLAN hotspot connection is available.
WLAN hostspot clients are integrated with the device's connection selection user interfaces, with automatic Internet Access Point selection and with seamless roaming.
the user does not need to run a hotspot client separately before running the actual application that the user wants to use. Instead, the hotspot application can be run automatically when needed.

The invention is not limited to the embodiment described above, and various modifications are possible.

For example, the invention is not limited to WLAN, but can also be applied to other connection networks such as Bluetooth, WiMAX and the like in which it is possible to connect to different access entities which may have different profiles and it is necessary to perform an authentication. That is, the access client (hotspot client) could be any authentication client that performs an authentication task before the connection is “released” to other applications.

Moreover, it is not even necessarily restricted to radio networks, it is also applicable to wired networks, when a connection to an network access entity is achieved via a wired access point by using a cable (such as a LAN connection or the like). In this case, different specifications of the wired access point can be considered by using different access clients. For example, the present invention can be applied to xDSL or other wired broadband connections.

Moreover, in the above description of the preferred embodiment, the “hotspot” is only an example for a network access entity. That is, also other forms of a network access entity are possible.

Furthermore, according to the embodiment described above, the WLAN hotspot client (as an example for an access client entity) and the operating system (as an example for an operation entity) are implemented as software within a computer running the network device. However, the access client entity and the operation entity may also be realized as hardware such as ASICs, DSPs or the like, so that different access client entities may also be replaced or used by inserting corresponding components into a suitable socket or the like of the network device.

1. (canceled)

2. A method, comprising:
operating an operation entity for handling network connection, wherein at least one access client entity providing connection handling to a specific network access device is connectable to the operation entity,
identifying, by the operation entity, a need for a network connection, and
requesting the access client entity to perform authentication.

3. A method, comprising:
operating an access client entity for handling a network connection to a specific network access device, connectable to a network device comprising an operation entity for handling network connection,
receiving a request from the operation entity to perform authentication, and
performing the authentication.

4. (canceled)

5. The method according to claim 2, wherein a plurality of access client entities is provided, and the identifying step comprises the step of selecting an access client entity of the plurality of access client entities based on the need for a network connection.

6. The method according to claim 2, wherein a message is sent from the access client entity to the operating system client to request the operating system client to notify when a certain connection profile becomes available.

7. The method according to claim 2, wherein a message is sent from the operating system client to the access client entity to request the access client entity to notify when a certain connection profile becomes available.

8. The method according to claim 2, wherein a message is sent from the operation entity to the access entity client by which the operation entity requests the access client entity to perform the authentication.

9. The method according to claim 2, wherein a message is sent from the operation entity to the access entity client by which the operation entity requests the access client entity to perform a de-authentication.

10-12. (canceled)

13. The method according to claim 2, further comprising
prohibiting a modification of a network connection setting by a user input.

14. The method according to claim 2, further comprising
registering an access client entity to the operation entity.

15. The method according to claim 2, further comprising
linking an access client entity to a profile, wherein in the authenticating step, the operation entity informs the access client entity linked to the profile in case a connection with the profile is to be established.

16-28. (canceled)

29. A device,
wherein the device is configured to provide connection handling for a specific network access device, comprising
a receiver configured to receive a request to perform authentication from an operation entity, and
a performer configured to perform the authentication.

30. (canceled)

31. The access client entity according to claim 29, further comprising means for sending a message to the operation entity to request the operation entity to notify when a certain connection profile becomes available.

32. The device according to claim 29, further comprising a receiver configured to receive a message requesting the device to notify when a certain connection profile becomes available.

33. The entity device according to claim 29, further comprising a receiver configured to receive a message by which the entity device is requested to perform the authentication.

34. The device according to claim 29, further comprising a receiver configured to receive a message by which the access client entity is requested to perform a de-authentication.

35-37. (canceled)

38. The device according to claim 29, further comprising a registering unit configured to register to the operation entity.

39. A device,
wherein the device is configured to handle network connection, comprising
an identify unit configured to identify a need for a network connection, and
a request unit configured to request an access client entity providing connection handling for a specific network access device to perform an authentication.

40. (canceled)

41. The device according to claim 39, further comprising a selector configured to select an access client entity of a plurality of access client entities based on the need for a network connection.

42. The device according to claim 39, further comprising a receiver configured to receive a message requesting to notify when a certain connection profile becomes available.

43. The device according to claim 39, further comprising a sender configured to send a message to the access client entity requesting to notify when a certain connection profile becomes available.

44. The device according to claim 39, further comprising a sender configured to a message to the access client entity requesting the access client entity to perform the authentication.

45. The device according to claim 39, further comprising a sender configured to send a message to the access client entity requesting the access client entity to perform a de-authentication.

46-48. (canceled)

49. The operation entity according to claim 39, further comprising a prohibiting unit configured to prohibit a modification of a network connection setting by a user input.

50. The operation entity according to claim 39, further comprising registration unit configured to register an access client entity.

51. The device according to claim 39, further comprising a link unit configured to link an access client entity to a profile, wherein the device is configured to inform the access client entity linked to the profile in case a connection with the profile is to be established.

52. A computer program product embodied on a computer readable medium, the computer program comprising program code for controlling a computer to perform:
operating an operation entity for handling network connection, wherein at least one access client entity providing connection handling to a specific network access device is connectable to the operation entity,
identifying, by the operation entity, a need for a network connection, and
requesting the access client entity to perform authentication.

53-54. (canceled)

55. A computer program product embodied on a computer readable medium, the computer program comprising program code for controlling a computer to perform:
operating an access client entity for handling a network connection to a specific network access device, connectable to a network device comprising an operation entity for handling network connection,
receiving a request from the operation entity to perform authentication, and
performing the authentication.

56. A device, comprising:
means for operating an operation entity for handling network connection, wherein at least one access client entity providing connection handling to a specific network access device is connectable to the operation entity,
means for identifying a need for a network connection, and
means for requesting the access client entity to perform authentication.

57. A device, comprising:
means for operating an access client entity for handling a network connection to a specific network access device, connectable to a network device comprising an operation entity for handling network connection,
means for receiving a request from the operation entity to perform authentication, and
means for performing the authentication.

58. The method according to claim 3, wherein a plurality of access client entities is provided, and the identifying comprises selecting an access client entity of the plurality of access client entities based on the need for a network connection.

59. The method according to claim 3, wherein a message is sent from the access client entity to the operating system client to request the operating system client to notify when a certain connection profile becomes available.

60. The method according to claim 3, wherein a message is sent from the operating system client to the access client entity to request the access client entity to notify when a certain connection profile becomes available.

61. The method according to claim 3, wherein a message is sent from the operation entity to the access entity client by which the operation entity requests the access client entity to perform the authentication.

62. The method according to claim 3, wherein a message is sent from the operation entity to the access entity client by which the operation entity requests the access client entity to perform a de-authentication.

63. The method according to claim 3, further comprising:
prohibiting a modification of a network connection setting by a user input.

64. The method according to claim 3, further comprising:
registering an access client entity to the operation entity.

65. The method according to claim 3, further comprising:
linking an access client entity to a profile, wherein in the authenticating step, the operation entity informs the access client entity linked to the profile in case a connection with the profile is to be established.
